(19) United States
(12) Patent Application Publication
(10) Pub. No.: US 2007/0292040 A1
(43) Pub. Date: Dec. 20, 2007

(54) Image judging device and image judging method

(75) Inventor: Ayahiro Nakajima, Matsumoto-shi (JP)

Correspondence Address: EDWARDS ANGELL PALMER & DODGE LLP, P.O. BOX 55874, BOSTON, MA, 02205, US

(73) Assignee: Seiko Epson Corporation, Tokyo (JP)

(21) Appl. No.: 11/708,878

(22) Filed: Feb. 20, 2007

(30) Foreign Application Priority Data
Feb. 20, 2006 (JP) 2006-042548

(51) Int. Cl. G06K 9/36

(52) U.S. Cl. 382/250

(57) ABSTRACT

An image judging device for judging whether an image represented by input image data is a defocused image or not includes an evaluation value calculating unit and a judgment unit. The evaluation value calculating unit calculates a predetermined evaluation value on the basis of normalized orthogonal transform coefficients acquired from the input image data encoded by a normalized orthogonal transform. The judgment unit judges whether an image represented by the input image data is a defocused image or not on the basis of the calculated evaluation value.

### BACKGROUND

1. Technical Field

The present invention relates to a technology for judging whether an image represented by input image data is a focused image.

2. Related Art

Generally, image data representing an image captured by a digital camera is stored in a memory card inserted into the digital camera. Since the image data stored in the memory card can be easily deleted after the photographs have been taken, a user can take another photograph without worrying about wasting storage space. In addition, since a large amount of image data can be stored in one memory card thanks to a recent increase in storage capacity of memory cards, the user can store a very large amount of image data in the memory card.

The image data stored in the memory card may include image data of images having a low likelihood of being printed in the future such as defocused images. Accordingly, when images represented by the image data stored in the memory card are to be printed, a user needs to display the image data stored in the memory card on a display unit of a digital camera or a printer and to select focused images. Such a selection operation becomes more troublesome as the amount of image data stored in the memory card increases.

In order to facilitate the selection operation, it is required to automatically judge whether an image represented by image data is a focused image or a defocused image (hereinafter, referred to as “defocus judgment”). The term “defocused image” means that the image is defocused.

For example, by judging whether the edge size (edge width) of an image detected using a technology (for example, see JP-A-10-340332) of detecting an edge of an image on the basis of image data of a bitmap format, the defocus judgment may be performed.

However, since the image data obtained and stored by a digital camera is generally formed of compressed image data of a JPEG (Joint Photographic Coding Experts Group) format, it takes a time to develop the compressed image data of a JPEG format into the image data of a bitmap format. Accordingly, a certain amount of time is required to perform the defocus judgment. It is predicted that the amount of time required for the defocus judgment becomes larger as the amount of image data stored in the memory card increases.

### SUMMARY

An advantage of some aspects of the invention is that it provides a technology for performing a defocus judgment on an image represented by input image data at high speed.

According to an aspect of the invention, there is provided an image judging device for judging whether an image represented by input image data is a defocused image. The image judging device includes an evaluation value calculating unit for calculating an evaluation value on the basis of normalized orthogonal transform coefficients acquired from the input image data encoded by a normalized orthogonal transform and a judgment unit for judging whether an image represented by the input image data is a defocused image on the basis of the calculated evaluation value.

According to the image judging device, since the defocus judgment can be performed using the evaluation value calculated on the basis of the normalized orthogonal transform coefficients, it is possible to perform the defocus judgment of the image represented by the input image data.

Here, the normalized orthogonal transform may be a discrete cosine transform and the evaluation value calculating unit may calculate the evaluation value on the basis of discrete cosine transform coefficients as the normalized orthogonal transform coefficients acquired from the input image data encoded by the discrete cosine transform.

According to this configuration, it is possible to easily calculate the evaluation value of the image data encoded by the discrete cosine transform, such as image data of a JPEG format.

The evaluation value calculating unit may calculate the evaluation value on the basis of the discrete cosine transform coefficients corresponding to a predetermined low frequency.

In this case, it is possible to perform the defocus judgment with high precision.

For example, the evaluation value calculating unit may calculate a coefficient integrated value R1 obtained by integrating absolute values of the discrete cosine transform coefficients corresponding to a first frequency which is lowest, a coefficient integrated value R2 obtained by integrating absolute values of the discrete cosine transform coefficients corresponding to a second frequency which is the second lowest, and a coefficient integrated value R3 obtained by integrating absolute values of the discrete cosine transform coefficients corresponding to a third frequency which is the third lowest and may calculate the predetermined evaluation value expressed by Fb=(R1−R2)/(R2−R3) on the basis of the calculated coefficient integrated values R1, R2, and R3.

In the image judging device, the judgment unit may judge that the image represented by the input image data is a focused image when the calculated evaluation value is within a predetermined range and may judge that the image represented by the input image data is a defocused image when the calculated evaluation value is not within the predetermined range.

In this case, it is possible to easily perform the defocus judgment.

As described above, when the defocus judgment is performed by judging whether the calculated evaluation value is within the predetermined range, the image judging device may further include an evaluation threshold determining unit for determining evaluation threshold values defining the predetermined range. Here, the evaluation threshold determining unit may determine the evaluation threshold values corresponding to an output size indicating a size of the image represented by the input image data and an image size indicating a resolution of the input image data, with reference to evaluation threshold information prepared in advance.

In this case, it is possible to easily determine the predetermined range.

The image judging device may further include a printing unit for printing an image not judged to be a defocused image by the judgment unit.

In this case, the image judging device according to the aspect of the invention can be used as a printer.

In the image judging device, the evaluation value calculating unit may set one or more evaluation areas in the image represented by the input image data and may calculate the predetermined evaluation value for every set evaluation area. Here, the judgment unit may judge that the image represented by the input image data is a defocused image when all the evaluation areas are judged to be defocused and may judge that the image represented by the input image data is a focused image when one of the evaluation areas is judged to be focused, on the basis of the evaluation value calculated for every evaluation area.

In this case, an image which is photographed in a state where a part of the image represented by the input image data is focused but which is judged to be a defocused image when the defocus judgment is performed to the whole image can be judged to be a focused image.

The invention may be embodied as a variety of aspects of an aspect as a variety of image output devices such as a printer having the image judging device, an aspect as an image judging method, an aspect as a computer program, an aspect as a recording medium having a computer program recorded thereon, an aspect as data signals embodied in carrier waves so as to include the computer program, and the like, in addition to the configuration as the above-described image judging device.

When the invention is embodied as a computer program or a recording medium having the program recorded thereon, the invention may be realized as an entire program controlling operations of the above-mentioned device or a part of the program performing only functions of the invention. Examples of the recording medium can include a variety of computer-readable mediums such as a flexible disc, a CD-ROM, a DVD-ROM/RAM, an optical magnetic disc, an IC card, a ROM cartridge, a punch card, a printed matter in which codes such as barcodes are printed, and an internal storage (memory such as RAM or ROM) and an external storage of a computer.

### BRIEF DESCRIPTION OF THE DRAWINGS

The invention will be described with reference to the accompanying drawings, wherein like numbers reference like elements.

FIG. 1 is a diagram illustrating a schematic configuration of a printer as an example of an image judging device according to an embodiment of the invention.

FIG. 2 is a flowchart illustrating a procedure of an automatic printing process.

FIG. 3 is a flowchart illustrating a procedure of a defocus judging process.

FIG. 4 is a flowchart illustrating a procedure of an evaluation value calculating process.

FIG. 5 is a diagram schematically illustrating DCT coefficient blocks acquired in the process of step S252.

FIG. 6 is a graph illustrating coefficient integrated values of frequency components.

FIG. 7 is a flowchart illustrating a procedure of a defocus judging process according to a second embodiment of the invention.

FIG. 8 is a diagram illustrating set evaluation areas.

### DESCRIPTION OF EXEMPLARY EMBODIMENTS

Hereinafter, the present invention will be described with reference to exemplary embodiments as follows:

A. First Embodiment

A1. Summary of Printer Configuration

A2. Summary of Automatic Printing Operation

A3. Defocus Judging Process

B. Second Embodiment

C. Modified Examples.

### A. First Embodiment

### A1. Summary of Printer Configuration

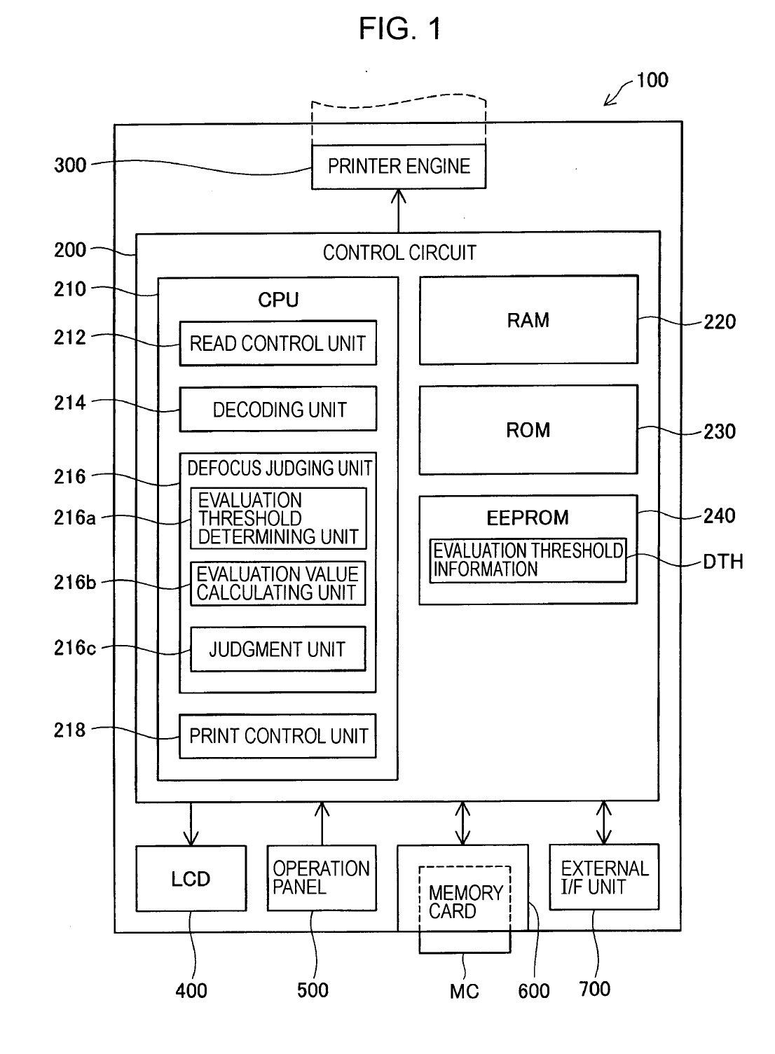

FIG. 1 is a diagram illustrating a schematic configuration of a printer 100 as an example of an image judging device according to an embodiment of the invention. As shown in the figure, the printer 100 includes a control circuit 200, a printer engine 300 connected to the control circuit 200, a liquid crystal display (LCD) 400, an operation panel 500, a memory card slot 600, and an external interface unit 700.

The printer engine 300 includes a carriage (not shown) mounted with an ink cartridge, a motor driving the carriage, and a paper transport motor (not shown) transporting a sheet of paper in a secondary scanning direction and serves as a functional unit for performing a printing operation.

The liquid crystal display 400 is a functional unit for displaying a variety of menu icons or an image represented by image data read out by the printer 100.

The operation panel 500 includes operation buttons (not shown) used by a user to perform various settings.

The memory card slot 600 is a functional unit for reading out stored image data from an inserted memory card MC.

The external interface unit 700 includes a group of interfaces for connecting apparatuses such as a digital camera and a computer to the printer 100 through a cable.

The control circuit 200 includes a CPU 210, a RAM 220, a ROM 230, and an EEPROM 240. Control programs for controlling all the operations of the printer 100 or a variety of application programs are stored in the ROM 230. Printing condition information automatically set in an automatic printing operation to be described later, image data read out from the memory card MC or the digital camera, or the like is temporarily stored in the RAM 220. Evaluation threshold information DTH to be described later is stored in the EEPROM 240. The printing condition information is set by a user's operation of the operation panel 500 and may be stored in the RAM 220.

The CPU 210 serves as a read control unit 212, a decoding unit 214, a defocus judging unit 216, and a print control unit 218 for performing an automatic printing operation by executing an application program for automatic printing stored in the ROM 230 with the execution of the automatic printing operation instructed by the user's operation of the operation panel 500.

The read control unit 212 is a function unit for reading image data from the memory card MC inserted into the memory card slot 600 or an apparatus such as a digital camera connected thereto through the external interface unit 700.

When the read image data is compressed image data in the JPEG format, the decoding unit 214 acts as a functional unit for decompressing the compressed image data to acquire decompressed image data such as image data in the bitmap format.

The defocus judging unit 216 is a functional unit for judging whether an image represented by the read image data is a defocused image or a focused image. The defocus judging unit 216 includes three functional parts of an evaluation threshold determining unit 216a, an evaluation value calculating unit 216b, and a judgment unit 216c and the individual functional parts will be described in detail later.

The print control unit 218 is a functional unit for controlling the printer engine 300 to print an image selected as an image to be printed.

In the printer 100 having the above-mentioned configuration, when the automatic printing operation is performed, images represented by image data stored in the memory card MC are first subjected to a defocus judging process and an image judged as being not defocused, that is, an image judged as being focused, is selected and printed as an image to be printed.

### A2. Summary of Automatic Printing Process

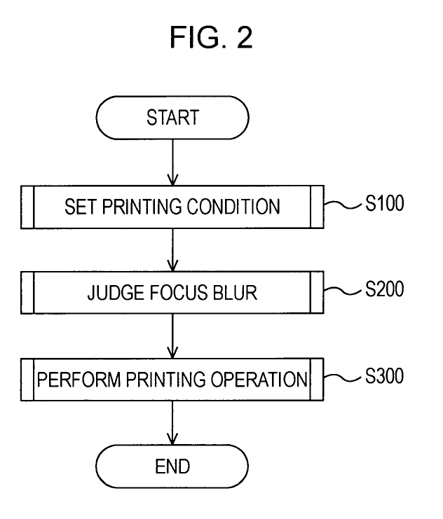

FIG. 2 is a flowchart illustrating a procedure of the automatic printing process. In the printer 100, the CPU 210 performs the automatic printing process by the procedure shown in FIG. 2 in response to a user's operation of the operation panel 500 in accordance with the menu icon (not shown) displayed on the liquid crystal display 400 to select an “automatic printing menu.” Here, an example in which the automatic print is performed for the image data stored in the memory card MC will be described. However, a read source of the image data may be any of a variety of apparatuses such as a digital camera connected to the printer 100 through the external interface unit 700. The selection of the “automatic printing menu” can be performed by a user's operation of the operation panel 500 to designate the read source of the image data.

When the automatic printing process is started, first, the print control unit 218 of the CPU 210 sets printing conditions (step S100). The set printing condition information includes information (information corresponding to a size of a printed image, that is, an output size) indicating a size (hereinafter, referred to as “print size”) such as a postcard size, an L plate size, and an A4 size of a printing sheet or information indicating a direction such as a longitudinal direction and a horizontal direction, and information indicating the number of printing sheets. The printing condition information is stored in advance as default data used in the automatic printing program in the RMO 230 or the EEPROM 240 and the printing conditions can be automatically set by reading out the default data. The set printing condition information is stored in a predetermined area of the RAM 220. However, for example, when selecting the “automatic printing menu”, the print size or the number of printing sheets may be selected by the user's operation of the operation panel 500.

After setting the printing conditions, the defocus judging unit 216 of the CPU 210 reads out image data stored in the memory card MC and performs the defocus judgment (step S200). The judgment result is associated with identification information of the image judged as being defocused and then is stored as defocus judgment result information in a predetermined area of the RAM 220. The defocus judgment will be described in detail later.

After ending the defocus judgment, the print control unit 218 of the CPU 210 selects and prints the image judged as not being defocused, that is, the image judged as being focused, on the basis of the judgment result information stored in the RAM 220 (step S300). When a plurality of images judged as not being defocused exist, the images are sequentially selected and printed in a predetermined order such as a recording order in the memory card MC, a defocus judgment order, and an alphabet order of file names of the image data which were previously determined.

### A3. Defocus Judging Process

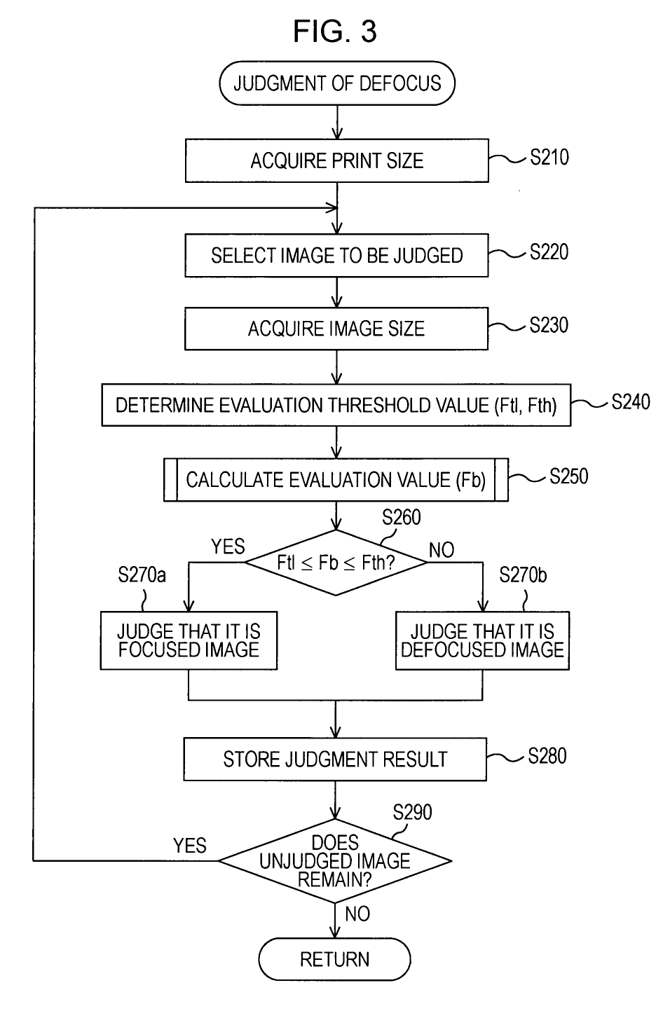

Now, the defocus judgment process which is a feature of the invention will be described in detail. FIG. 3 is a flowchart illustrating a procedure of the defocus judging process.

When the defocus judging process is started, first, the evaluation determining unit 216a of the defocus judging unit 216 reads out the printing condition information stored in the Ram 220 and acquires the print size (step S210). Next, the evaluation threshold determining unit 216a selects one image to be subjected to the defocus judging process as an image to be judged from among the images represented by the image data stored in the memory card MC, reads out the image data of the image to be judged from the memory card MC through the read control unit 212, and stores the read image data in the RAM 220 (step S220). The selection of the image to be judged is performed in a predetermined order such as an order (recording order) in which the image data are stored in the memory card MC and an alphabet order of the file names which are identification information of the image data. The evaluation threshold determining unit 216a reads out image data from the RAM 220 to acquire the image size (step S230). Next, the evaluation threshold determining unit 216a determines evaluation threshold values Fth and Ftl corresponding to the acquired print size and image size with reference to the evaluation threshold information DTH stored in the EEPROM 240 (step S240). The evaluation threshold information DTH includes the evaluation threshold values Fth and Ftl corresponding to each print size and each image size and the evaluation threshold values Fth and Ftl corresponding to the print size acquired in step S210 and the image size acquired in step S230 are determined with reference to the evaluation threshold information DTH in step S240 of FIG. 3. The evaluation threshold values will be described in detail later.

When the evaluation threshold values are determined by the evaluation threshold determining unit 216a, the evaluation value calculating unit 216b of the defocus judging unit 216 calculates the evaluation values Fb (step S250).

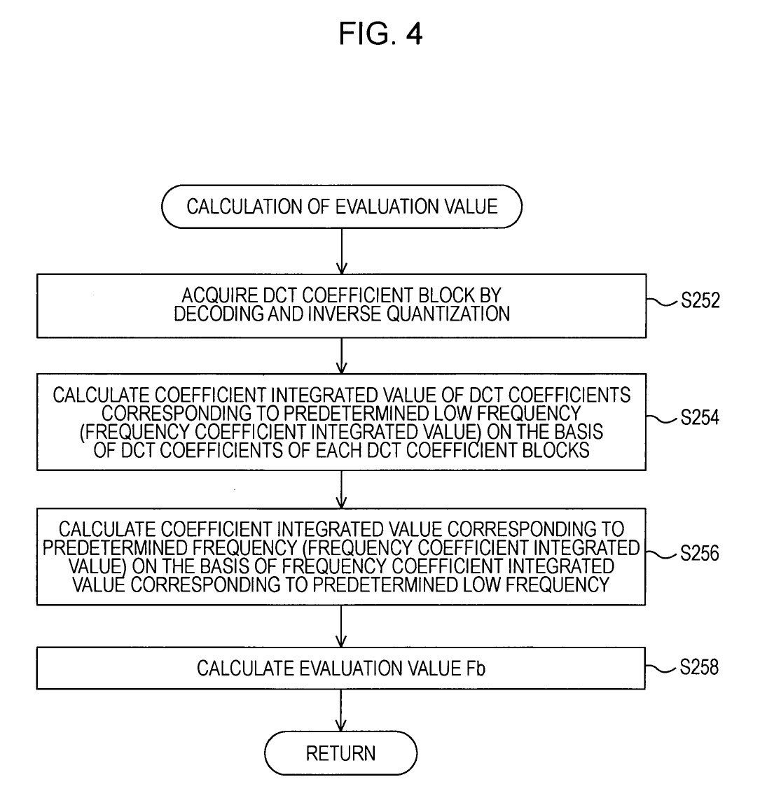

FIG. 4 is a flowchart illustrating a procedure of an evaluation calculating process. First, the evaluation value calculating unit 216b controls the decoding unit 214 for executing a known process (hereinafter, referred to as a “decoding process”) of converting image data in the JPEG format (hereinafter, for brevity, referred to as “JPEG image data”) into image data in the bitmap format (hereinafter, referred to as “bitmap image data”), reads out the JPEG image data stored in the RAM 220, performs decoding and inverse quantization as a part of the decoding process, and acquires blocks of discrete cosine transform (DCT) coefficients (hereinafter, also referred to as “DCT coefficient blocks”), which are included in the JPEG image data, each image block of 8×8 pixels serving as a unit of processing at the time of converting the bit-map image data into the JPEG image data (step S252).

Next, the evaluation value calculating unit 216b calculates a coefficient integrated value (hereinafter, referred to as “coefficient integrated value of frequency components”) of the DCT coefficients corresponding to a predetermined frequency component on the basis of the DCT coefficients included in the acquired DCT coefficient blocks (step S254). Specifically, the coefficient integrated value of frequency components is calculated as described below.

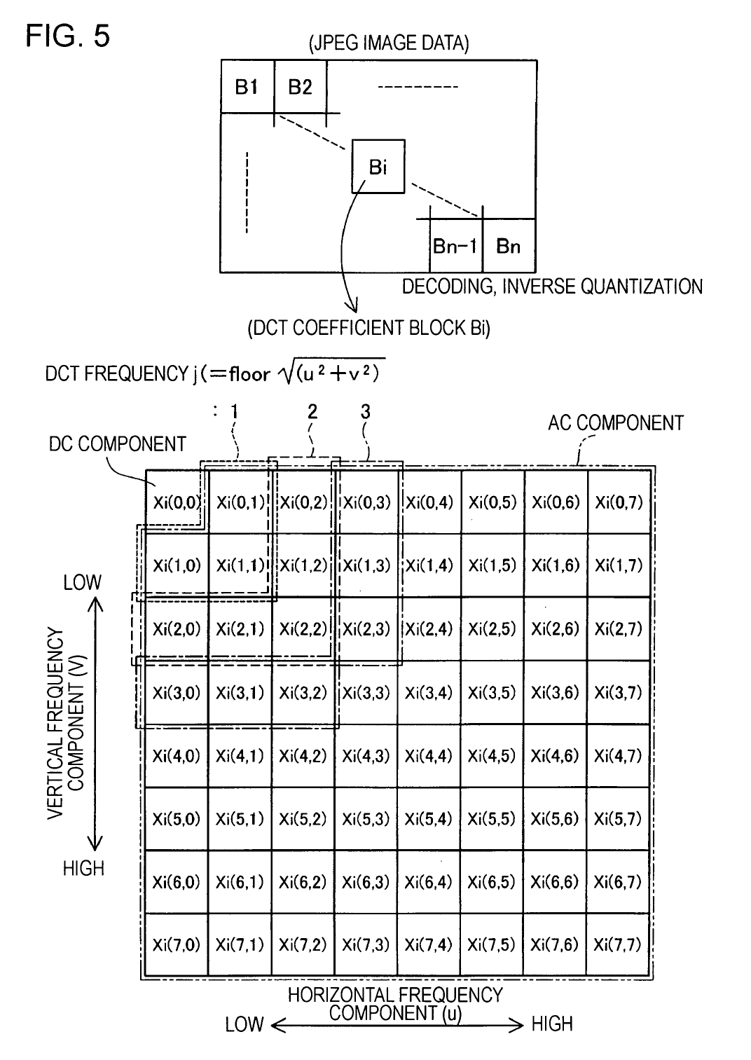

FIG. 5 is a diagram schematically illustrating the DCT coefficient blocks acquired in the process of step S252. The upper portion of FIG. 5 shows the JPEG image data and the lower portion schematically shows the i-th (where i is an integer selected from 1 to n) DCT coefficient block Bi which can be acquired in the process of step S252.

As shown in the lower portion of FIG. 5, 8×8 DCT coefficients of one DCT coefficient block Bi can be acquired as a result of the process of step S252. Here, the DCT coefficients of the DCT coefficient block Bi are classified into horizontal frequency components u (=0, 1, 2, 3, 4, 5, 6, and 7) and vertical frequency components v (=0, 1, 2, 3, 4, 5, 6, and 7) and a DCT coefficient of a frequency component (u,v) is expressed by Xi(u,v). Xi(0,0) indicates a DCT coefficient of a DC component and the DCT coefficients other than Xi(0,0) indicate DCT coefficients of AC components.

The evaluation value calculating unit 216b calculates coefficient integrated values S01 to S03, S10 to S13, S20 to S23, and S30 to S32 of the frequency components of (0,1) to (0,3), (1,0) to (1,3), (2,0) to (2,3), and (3,0) to (3,2) among coefficient integrated values Suv acquired by integrating the DCT coefficients of the frequency components (u,v) obtained from the blocks B1 to Bn by using Expression (1).

[symbol]

Referring again to FIG. 4, the evaluation value calculating unit 216b calculates coefficient integrated values corresponding to a predetermined frequency (hereinafter, referred to as “frequency coefficient integrated value”) on the basis of the coefficient integrated values of predetermined low-frequency components acquired as described above (step S256).

Specifically, among frequency coefficient integrated values Rj obtained by integrating the coefficient integrated values of frequency components (u,v) corresponding to a frequency j expressed by Expression (2) by using Expression (3), the frequency coefficient integrated values R1, R2, and R3 of frequencies j=1, 2, and 3, respectively, are calculated. Here, a function floor [ ] of Expression (2) means to round off a fraction.

[symbol]

The frequency components of the DCT coefficients corresponding to a frequency j correspond to the DCT coefficients of AC components arranged around the left-upper DC component in the DCT coefficient block shown in FIG. 5. For example, the frequency components (u,v) corresponding to the frequency j=1 are (0,1), (1,0), and (1,1) and thus the frequency coefficient integrated value R1 is expressed by Expression (4a). The frequency components (u,v) corresponding to the frequency j=2 are (0,2), (2,0), (2,2), (1,2), and (2,1) and thus the frequency coefficient integrated value R2 is expressed by Expression (4b). The frequency components (u,v) corresponding to the frequency j=3 are (0,3), (3,0), (1,3), (2,3), (3,1), and (3,1) and thus the frequency coefficient integrated value R3 is expressed by Expression (4c).

R1=S01+S10+S11 (4a)

R2=S02+S20+S22+S12+S21 (4b)

R3=S03+S30+S13+S23+S31+S32 (4c)

Next, the evaluation value calculating unit 216b calculates the evaluation value Fb by using Expression (5) on the basis of the calculated frequency coefficient integrated values R1, R2, and R3.

Fb=(R1−R2)/(R3−R2) (5)

When the evaluation value Fb is calculated by the evaluation value calculating unit 216b, the procedure returns to the processes of FIG. 3 and the judgment unit 216c of the defocus judging unit 216 judges whether the calculated evaluation value Fb is within a predetermined range defined by the evaluation threshold values Ftl and Fth as expressed by Expression (6).

Ftl≦Fb≦Fth (6)

The judgment unit 216c judges that the image to be judged is a focused image (step S270a) when the evaluation value Fb is within the predetermined range (YES in step S260), judges that the image to be judged is a defocused image (step S270b) when the evaluation value Fb is not in the predetermined range (NO in step S260), and stores the judgment result as the defocus judgment result information in a predetermined area of the RAM 220 (step S280).

Next, the judgment unit 216c judges whether image data of a non-judged image having not yet been subjected to the defocus judgment remains in the memory card MC (step S290). At this time, the judgment unit 216c repeats the processes of steps S220 to S280 when non-judged image data remains (YES in step S290) and ends the defocus judging process when no non-judged image data remains (NO in step S290).

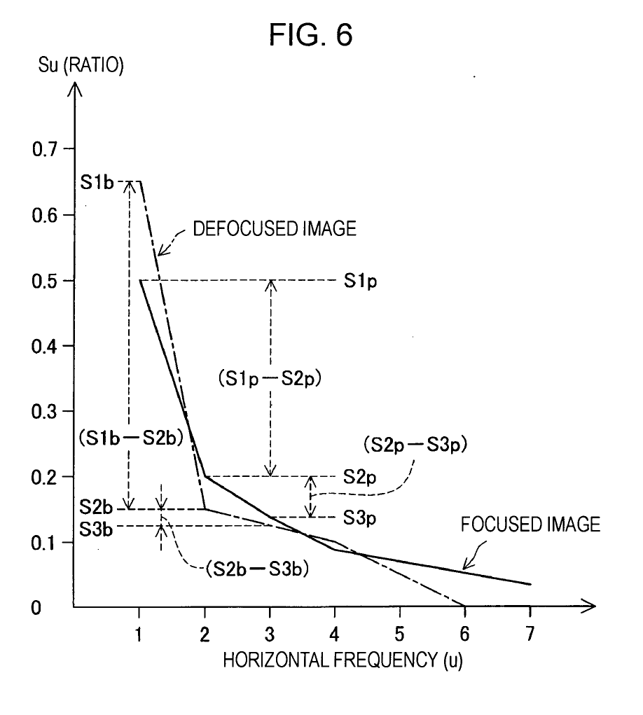

Here, the evaluation value Fb and the threshold values Ftl and Fth will be described with reference to FIG. 6. FIG. 6 is a graph illustrating coefficient integrated values of frequency components. In FIG. 6, the horizontal axis denotes the horizontal frequency components u and the vertical axis denotes the coefficient integrated values Su0 of frequency components (hereinafter, simply abbreviated as “Su”) at the vertical frequency component v=0 and the horizontal frequency components u=1, 2, 3, 4, 5, 6, and 7. Here, the coefficient integrated values Su denoted by the vertical axis are each expressed as a ratio to the sum of the coefficient integrated values Su of the horizontal frequency components u. An example of a graph of the defocused image is denoted by a dot-chained line and an example of a graph of the focused image is denoted by a solid line.

When three horizontal frequency components of u=1, 2, and 3 are noted in the graphs shown in FIG. 6, a difference (S1b-S2b) between S1b and S2b of a defocused image is larger than a difference (S1p-S2p) between S1p and S2p of a focused image and a difference (S2b-S3b) between S2b and S3b of the defocused image is smaller than a difference (S2p-S3p) between S2p and S3p of the focused image. In this way, the inventor determined through experiments the fact that the frequency components of the DCT coefficients vary with a certain tendency in the focused image and the defocused image, that is, such a tendency is marked for three horizontal frequency components of u=1, 2, and 3. This fact is true of the frequency components in the vertical direction and the frequency components in the horizontal direction and the vertical direction, in addition to the frequency components in the horizontal direction.

Accordingly, the evaluation value Fb of the defocused image calculated by Expression (5) has a tendency to be larger than that of the focused image. Therefore, an upper limit of the evaluation value Fb varying from the evaluation value Fb of an image considered to be a focused image by a user to the evaluation value Fb of an image considered to be a defocused image by a user is experimentally calculated and the calculated evaluation value Fb is set as the evaluation threshold value Fth. When the evaluation value is larger than the evaluation threshold value Fth, the image to be judged is judged to be a defocused image.

The inventor determined the fact that an image for which a difference (R2−R3) between R2 and R3 is negative and the evaluation value Fb is negative or an image for which a difference (R1−R2) between R1 and R2 is smaller than that of a focused image and the evaluation value Fb is close to “0” exists among the defocused images. Accordingly, a lower limit of an evaluation value Fb varying from an evaluation value of an image considered to be a focused image by a user to an evaluation value Fb of an image considered to be a defocused image by a user is also experimentally calculated and the calculated evaluation value Fb is set as the evaluation threshold value Ftl. When the evaluation value is smaller than the evaluation threshold value Ftl, the image to be judged is judged to be a defocused image.

The evaluation threshold information DTH includes the evaluation threshold values Fth and Ftl experimentally calculated in advance for every print size and image size. Accordingly, the evaluation threshold values Fth and Ftl corresponding to the print size acquired in step S210 of FIG. 3 and the image size acquired in step S230 are determined with reference to the evaluation threshold information DTH in step S240.

For example, when the print size is the L plate size and the image size is 5,000,000 pixels, Ftl=1.2 and Fth=5 are determined.

Since the width of the image judged to be a defocused image is determined on the basis of a viewing angle, the evaluation threshold values Fth and Ftl can be experimentally calculated by generating images whose edge width changes with a change in image size or print size and calculating the evaluation values Fb using Expression (1).

As described above, in the defocus judging process according to this embodiment, it can be judged on the basis of the DCT coefficients whether the image represented by the image data stored in the memory card MC is a defocused image or a focused image. Accordingly, since it is necessary to develop compressed image data of the JPEG format into decompressed image data of the bitmap format, it is possible to carry out the defocus judgment at high speed.

### B. Second Embodiment

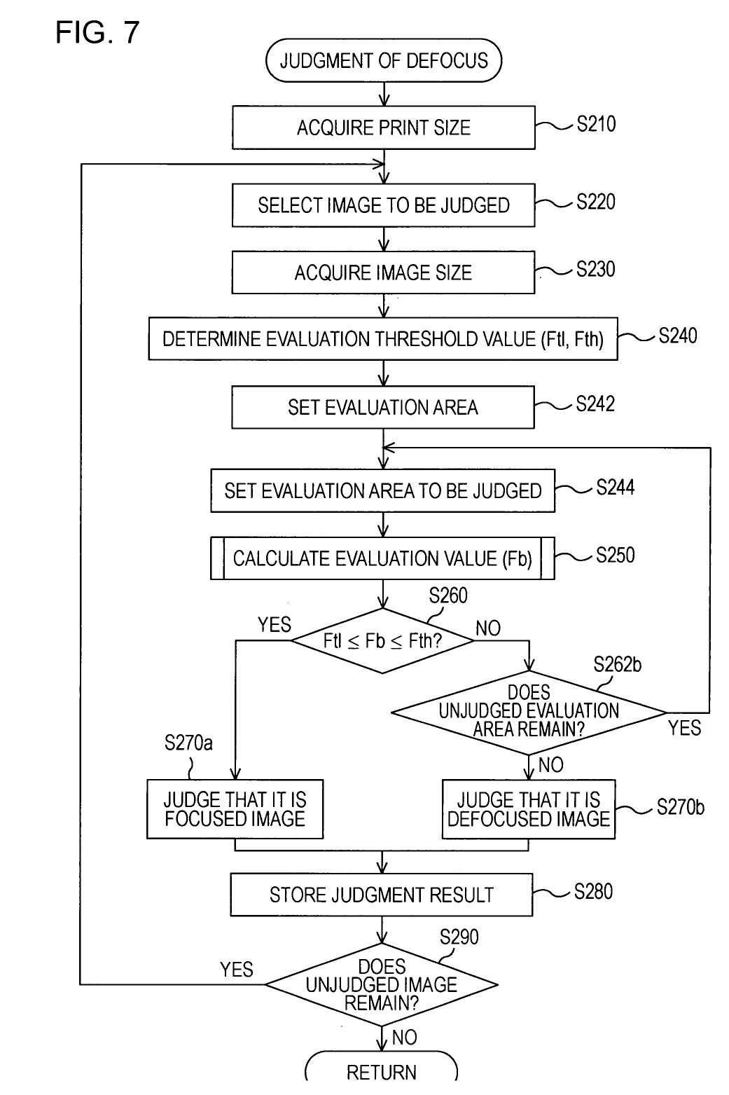

FIG. 7 is a flowchart illustrating a procedure of a defocus judging process according to a second embodiment of the invention. In the defocus judging process according to this embodiment, an evaluation area setting process (step S242) and an evaluation area to be judged selecting process (step S244) are additionally inserted between the process of step S240 and the process of S250 in the defocus judging process in the first embodiment shown in FIG. 3 and a process of judging existence of a non-judged evaluation area (step S262b) is additionally inserted between the process of step S260 and the process of step S270b.

In step S242, the evaluation value calculating unit 216b of the defocus judging unit 216 sets evaluation areas of the DCT coefficient blocks of the JPEG image data, as described below.

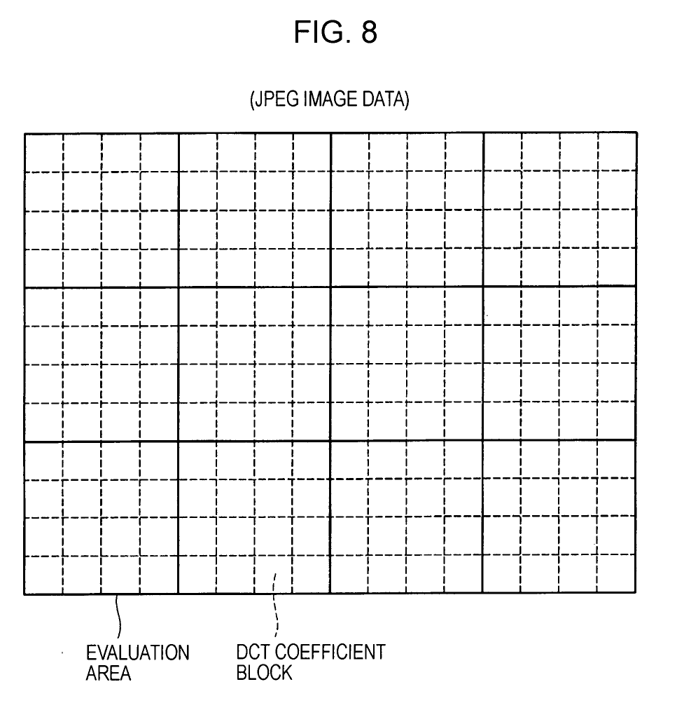

FIG. 8 is a diagram illustrating the set evaluation areas. As shown in FIG. 8, the evaluation value calculating unit 216b divides a plurality of DCT coefficient blocks constituting the JPEG image data into a plurality of blocks and sets a plurality of evaluation areas as a unit for calculating the evaluation value Fb in step S250. FIG. 8 shows an example where 16×12 DCT coefficient blocks are divided into 4×4 blocks and 4×3 evaluation areas are set.

Next, in step S244, the evaluation value calculating unit 216b selects one evaluation area to be subjected to the defocus judgment as an evaluation area to be judged among the plurality of set evaluation areas. Then, the evaluation value calculating unit 216b calculates the evaluation value Fb of the evaluation area to be judged (step S250).

When the evaluation value Fb of the evaluation area to be judged is calculated by the evaluation value calculating unit 216b, the judgment unit 216c of the defocus judging unit 216 judges whether the evaluation value Fb is within a predetermined range defined by the evaluation threshold values Ftl and Fth.

Here, when the evaluation value Fb of the evaluation area to be judged is within the predetermined range (YES in step S260), the judgment unit 216c judges that the image to be judged is a focused image (an image which is not defocused) (step S270a) similarly to the first embodiment and stores the judgment result as defocus judgment result information in a predetermined area of the RAM 220 (step S280). On the other hand, when the evaluation value Fb of the evaluation area to be judged is not in the predetermined range (NO in step S260), the judgment unit 216c judges whether a non-judged evaluation area which is not subjected yet to the defocus judgment remains in the evaluation areas set in step S242 (step S262b). When a non-judged evaluation area remains (YES in step S262b), a next evaluation area to be judged is selected again in step S244 and the processes subsequent to step S250 are performed. When no non-judged evaluation area remains (NO in step S262b), it is judged that the image to be judged is a defocused image (step S270b) and the judgment result is stored as defocused judgment result information in a predetermined area of the RAM 220 (step S280).

In this way, in the defocus judging process according to this embodiment, it is also possible to judge whether the image represented by the image data stored in the memory card MC is a defocused image or a focused image on the basis of the DCT coefficients. Accordingly, since it is not necessary to develop the compressed image data of the JPEG format into the decompressed image data of the bitmap format, it is possible to carry out the defocus judgment at a relatively high speed.

In the defocus judging process according to this embodiment, the defocus judgment of an image to be judged is performed every set evaluation area. The image to be judged is judged as a defocused image only when it is judged that all the evaluation areas are defocused and the image to be judged is judged as a focused image when any one evaluation area is focused. Accordingly, an image which is judged as a defocused image as a whole such as an image photographed with only a part of an object focused can be judged as a focused image, thereby enhancing precision in defocus judgment.

### MODIFIED EXAMPLES

The invention is not limited to the above-mentioned embodiments, but may be modified in various forms without departing from the gist of the invention. For example, the following modified examples can be considered.

### Modified Example 1

Although it has been described in the second embodiment as shown in FIG. 8 that a plurality of evaluation areas are set by dividing a plurality of DCT coefficient blocks constituting the JPEG image data into a plurality of blocks, the invention is not limited to it. For example, the evaluation areas may be set by sequentially making areas with a m×n block size (where n is an integer of 1 or more) out of line in a horizontal direction or a vertical direction in a plurality of blocks constituting the JPEG image data in the unit of a predetermined number of blocks. Alternatively, only one area with an m×n block size at a predetermined position may be set as the evaluation area.

### Modified Example 2

Although it has been described in the above-mentioned embodiments that the defocus judging process is performed as a part of the automatic printing process and that an image to be printed is automatically selected and printed on the basis of the defocus judgment result information acquired as a result of the defocus judgment, the invention is not limited to it. For example, images represented by the image data stored in the memory card MC may be displayed on the liquid crystal display 400 so as to distinguish an image judged as being focused and an image judged as being defocused from each other. Then, a user may select an image to be printed by operating the operation panel 500 while viewing the displayed images.

### Modified Example 3

It has been described in the above-mentioned embodiments that the images represented by a plurality of image data stored in the memory card MC are first subjected to the defocus judgment and then only focused images are selected and printed on the basis of the defocus judgment result information. However, the defocus judging process and the printing process may be performed every image.

### Modified Example 4

It has been described in the above-mentioned embodiments that the evaluation value Fb is calculated by the use of the frequency coefficient integrated values Rj obtained by integrating the frequency-component coefficient integrated values Suv of the DCT coefficients of the frequency components (u,v) corresponding to the frequency j having a size expressed by Expression (2). However, the invention is not limited to it, but the frequency coefficient integrated values Rj of only the horizontal frequency components corresponding to the frequency j may be calculated, the frequency coefficient integrated values Rj of only the vertical frequency components corresponding to the frequency j may be calculated, or the frequency coefficient integrated values Rj of only the horizontal frequency components and the vertical frequency components having the same values corresponding to the frequency j may be calculated.

### Modified Example 5

Although it has been described in the above-mentioned embodiments that a slope represented as a ratio of the difference (R1−R2) between R1 and R2 to the difference (R2−R3) between R2 and R3 as expressed by Expression (5) is calculated as the evaluation value Fb, the invention is not limited to it. A variety of slopes such as a slope (R1/R3) represented as a ratio of R1 to R3 and a slope represented as a ratio of the difference (R1−R2) between R1 and R2 to R1 may be used as the evaluation value. A difference (R1−R2) between R1 and R2, a difference (R2−R3) between R2 and R3, and the like may be used as the evaluation value. However, in this case, as described in the embodiment shown in FIG. 6, since it is necessary to calculate the frequency coefficient integrated values as a ratio with respect to the total sum of the frequency coefficient integrated values, it is necessary to calculate the frequency coefficient integrated values other than R1, R2, and R3. Since the DCT coefficient values vary with a difference in brightness of images and the coefficient integrated values also vary with the number of DCT coefficient blocks, there is an advantage that it is not necessary to calculate the frequency coefficient integrated values as ratios when one of the coefficient integrated values is calculated as a slope.

### Modified Example 6

Although it has been described in the above-mentioned embodiments as shown in FIG. 6 that the defocus judgment is performed using the DCT coefficients of low-frequency components having a remarkable difference between the focused image and the defocused image, the defocus judgment may be performed using DCT coefficients of high-frequency components.

### Modified Example 7

Although it has been described in the above-mentioned embodiments that the defocus judgment is performed by judging whether an evaluation value is within the predetermined range defined by the evaluation threshold values, the defocus judgment may be performed using a plurality of evaluation values. In this case, as the evaluation values, a plurality of evaluation values in which methods using the DCT coefficients of low-frequency components are different from each other may be used as described in Modified Example 4 or an evaluation value based on the DCT coefficients of low-frequency components and an evaluation value based on the DCT coefficients of high-frequency components may be combined and used.

### Modified Example 8

Although it has been described in the above-mentioned embodiments that a predetermined evaluation value is calculated on the basis of the discrete cosine transform (DCT) coefficients acquired from the JPEG image data encoded using the DCT, the invention is not limited to it. A predetermined evaluation value may be calculated on the basis of normalized orthogonal transform coefficients acquired from the image data encoded using a variety of normalized orthogonal transforms such as a Hadamard transform and a discrete Fourier transform.

### Modified Example 9

Although it has been described in the above-mentioned embodiments that the printer is allowed to operate as the image judging device according to the invention, the invention is not limited to it. For example, digital video cameras or apparatuses having various computers such as a personal computer may be used as the image judging device according to the invention.

The disclosure of Japanese Patent Application No. 2006-42548 filed Feb. 20, 2006 including specification, drawings and claims is incorporated herein by reference in its entirety.

What is claimed is:

1. An image judging device for judging whether an image represented by input image data is a defocused image, the image judging device comprising:
an evaluation value calculating unit for calculating an evaluation value on the basis of normalized orthogonal transform coefficients acquired from the input image data encoded by a normalized orthogonal transform; and
a judgment unit for judging whether an image represented by the input image data is a defocused image on the basis of the calculated evaluation value.

2. The image judging device according to claim 1, wherein the normalized orthogonal transform is a discrete cosine transform, and
wherein the evaluation value calculating unit calculates the evaluation value on the basis of discrete cosine transform coefficients as the normalized orthogonal transform coefficients acquired from the input image data encoded by the discrete cosine transform.

3. The image judging device according to claim 2, wherein the evaluation value calculating unit calculates the evaluation value on the basis of the discrete cosine transform coefficients corresponding to a predetermined low frequency.

4. The image judging device according to claim 3, wherein the evaluation value calculating unit calculates a coefficient integrated value R1 obtained by integrating absolute values of the discrete cosine transform coefficients corresponding to a first frequency which is lowest, a coefficient integrated value R2 obtained by integrating absolute values of the discrete cosine transform coefficients corresponding to a second frequency which is the second lowest, and a coefficient integrated value R3 obtained by integrating absolute values of the discrete cosine transform coefficients corresponding to a third frequency which is the third lowest and calculates the predetermined evaluation value expressed by Fb=(R1−R2)/(R2−R3) on the basis of the calculated coefficient integrated values R1, R2, and R3.

5. The image judging device according to claim 1, wherein the judgment unit judges that the image represented by the input image data is a focused image when the calculated evaluation value is within a predetermined range and judges that the image represented by the input image data is a defocused image when the calculated evaluation value is not within the predetermined range.

6. The image judging device according to claim 5, further comprising an evaluation threshold determining unit for determining evaluation threshold values defining the predetermined range,
wherein the evaluation threshold determining unit determines the evaluation threshold values corresponding to an output size indicating a size of the image represented by the input image data and an image size indicating a resolution of the input image data, with reference to evaluation threshold information prepared in advance.

7. The image judging device according to claim 1, further comprising a printing unit for printing an image not judged to be a defocused image by the judgment unit.

8. The image judging device according to claim 1, wherein the evaluation value calculating unit sets one or more evaluation areas in the image represented by the input image data and calculates the predetermined evaluation value for every set evaluation area, and
wherein the judgment unit judges that the image represented by the input image data is a defocused image when all the evaluation areas are judged as being defocused and judges that the image represented by the input image data is a focused image when one of the evaluation areas is judged as being focused, on the basis of the evaluation value calculated for every evaluation area.

9. An image judging method of judging whether an image represented by input image data is a defocused image or not, the image judging method comprising:
(a) calculating a predetermined evaluation value on the basis of normalized orthogonal transform coefficients acquired from the input image data encoded by a normalized orthogonal transform; and
(b) judging whether an image represented by the input image data is a defocused image or not on the basis of the calculated evaluation value.

10. A program product for judging whether an image represented by input image data is a defocused image or not, the computer program allowing a computer to execute:
(a) a function of calculating a predetermined evaluation value on the basis of normalized orthogonal transform coefficients acquired from the input image data encoded by a normalized orthogonal transform; and
(b) a function of judging whether an image represented by the input image data is a defocused image or not on the basis of the calculated evaluation value.

11. A computer-readable recording medium having the computer program according to claim 10 recorded thereon.
